(19) United States
(12) Patent Application Publication
(10) Pub. No.: US 2009/0186160 A1
(43) Pub. Date: Jul. 23, 2009

(54) Beverage Packaging Coating Matrix

(75) Inventors: Christopher D. Timmons, Seattle, WA (US); Drew E. Johansson, Seattle, WA (US); Daniel Graham, Kenmore, WA (US)

Correspondence Address: ASEMBLON, INC;JEFFREY B. OSTER -- LEGAL DEPARTMENT, 15340 NE 92ND ST, SUITE B, REDMOND, WA, 98052, US

(73) Assignee: Asemblon.Inc.

(21) Appl. No.: 12/355,397

(22) Filed: Jan. 16, 2009

Related U.S. Application Data
(60) Provisional application No. 61/022,117, filed on Jan. 18, 2008.

(51) Int. Cl. B05D 1/02; B05D 1/18; C09D 5/00

(52) U.S. Cl. 427/427.5; 427/427.4; 427/435; 427/430.1; 524/588

(57) ABSTRACT

There is disclosed a coating matrix of an extremely thin or monolayer coating for glass or other beverage packaging surfaces. More specifically, there is disclosed materials that can be used to improve the shelf life of packaged materials, such as bottled beer. More specifically, there is disclosed an anti-oxidation coating comprising a cross-linked monolayer that has a hydrophobic character and bound to beverage packaging surface through surface hydroxyl groups and a silane moiety. Moreover, there is disclosed a metal ion chelating moiety as part of the coating matrix.

### CROSS REFERENCE TO RELATED APPLICATION

This patent application claims priority to U.S. provisional patent application 61/022,117 filed 18 Jan. 2008.

### TECHNICAL FIELD

The present disclosure provides a coating matrix of an extremely thin or monolayer coating for glass or other beverage packaging surfaces. This disclosure relates to materials that can be used to improve the shelf life of packaged materials, such as bottled beer. More specifically, the present disclosure provides an anti-oxidation coating comprising a cross-linked monolayer or multiple layer that is bound to a beverage packaging surface through surface hydroxyl groups and a silane moiety. Moreover, the present disclosure adds a metal ion chelating moiety to the coating matrix.

### BACKGROUND

It is standard practice to form containers from materials that are impermeable to oxygen, such as glass or metal, or of very low permeability, such as laminated polymeric material including a barrier layer that may be formed of, for instance, a blend of polypropylene and ethylene vinyl alcohol (see, for example, EP 142183). It is also known from U.S. Pat. Nos. 3,857,754 and 3,975,463 to form articles such as bottles from certain compositions that include certain saponified ethylene-vinyl acetate copolymers.

When the container is formed of a glass or metal body and is provided with a metal closure, then permeation of oxygen or other gas through the body and the closure is reduced due to the impermeability of the materials from which the body and closure are formed. However it has long been recognized that when conventional containers of this type are used for the storage of materials such as beer, the shelf life of the stored materials is very limited due to the ingress of gases. For instance the quality of the beer stored in glass bottles having metal caps tends to deteriorate after storage for a month or so.

One way of prolonging the storage life has been to provide a gasket of cork and aluminum foil between the closure and the container body but this is wholly uneconomic. Accordingly at present it is accepted that the shelf life of beer, especially in bottles, is rather limited.

Therefore, it would be very desirable to be able to improve the shelf life significantly whilst continuing to use conventional materials for the formation of the container body, the container closure and the gasket between the body and closure.

In many products in the food and beverage industry spoilage and/or shelf-life is largely affected by oxidation in a negative way. For example, in beer, metal ions Fe(II), Fe(III), Cu(I), and Cu(II) react with various oxygen-containing chemicals to produce free radical oxygen species, that are responsible for degrading the flavor and shortening the beer shelf life.

### SUMMARY

The present disclosure provides a surface treatment monolayer or multiple layers for coating beverage container surfaces to prevent oxidation of the beverage, comprising a polymerized mixture of an aqueous formula (I) of a composition having a structure:

Silane Moiety-saturated alkane chain-chelating moiety (I)

wherein the chelating moiety is chosen to match the metallic ions in the beverage.

Preferably, the composition is selected from the group consisting of: N-(2-aminoethyl)-3-aminopropylmethyldimethoxysilane; (3-trimethoxysilylpropyl)diethylenetriamine; N-(trimethoxysilylpropyl)ethylenetriamine, triacetic acid, sodium salt; 2-(trimethoxysilylpropanol)-1,3-diamino-N,N,N′,N′-tetraacetic acid; mixture of N-(2-aminoethyl)-3-aminopropylmethyldimethoxysilane and tetra(ethylene glycol)trimethoxysilane; mixture of 3-(trimethoxysilylpropyl)diethylenetriamine and tetra(ethylene glycol)trimethoxysilane; mixture of N-(trimethoxysilylpropyl)ethylenediamine, tridactic acid, sodium salt, and tetra(ethyleneglycol)trimethoxysilane; mixture of 2-(trimethoxysilylpropanol)-1,3-diamino-N,N,N′,N′-tetraacetic Acid and tetra(ethylene glycol)trimethoxysilane; vinylmethoxysilane, vinyltrimethoxysilane, vinylethoxysilane, vinyltriethoxysilane, 3-aminopropyltriethoxysilane, 3-glycidoxypropyltrimethoxysilane, 3-methacryloxypropyltrimethoxysilane, 3-mercaptopropyltrimethoxysilane, N-(1,3-dimethylbutylidene)-3-(triethoxysilyl)-1-propanamine, N,N′-bis[3-(trimethoxysilyl)propyl]ethylenediamine, N-(beta-aminoethyl)-gamma-aminopropylmethyldimethoxysilane, N-(beta-aminoethyl)-gamma-aminopropyltrimethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-glycidoxypropylmethyldimethoxysilane, 2-(3,4-epoxycyclohexyl)ethyltrimethoxysilane, gamma-methacryloxypropyltrimethoxysilane, gamma-methacryloxypropyltriethoxysilane, gamma-mercaptopropyltrimethoxysilane, gamma-mercaptopropyltriethoxysilane, N-[2-(vinylbenzylamino)ethyl]-3-aminopropyltrimethoxysilane, and combinations thereof. Preferably the metallic surface is selected from the group consisting of steel, a steel alloy, a carbon steel, aluminum, copper, brass, and combinations thereof.

The present disclosure provides a process for treating a surface of glass or an oxidizable metal or metal alloy, comprising:

(a) providing an aqueous or organic solution of a compound:

Silane Moiety-saturated alkane chain-chelating moiety (I);

wherein the chelating moiety is chosen to match the metallic ions in the beverage.

(b) applying the aqueous or organic solution of formula (I) to the surface of the glass or oxidizable metal or metal alloy; and

(c) polymerizing the composition onto the surface by a condensation reaction

Preferably, the chelating compound is silane linked to a hydroxylated surface. Preferably, the hydroxylated surface is silicon dioxide, having a triaminetetraacetate (TTA) chelating moiety. Preferably, the silane anchor moiety of the chelating compound is a polymerized mixture of a SiO₂ (formula (I) of a composition having a structure:

Silane Moiety-C2-20 alkane-chelating moiety (I)

Preferably, the compound is selected from the group consisting of: N-(2-aminoethyl)-3-aminopropylmethyldimethoxysilane; (3-trimethoxysilylpropyl)diethylenetriamine; N-(trimethoxysilylpropyl)ethylenetriamine, triacetic acid, sodium salt; 2-(trimethoxysilylpropanol)-1,3-diamino-N,N,N′,N′-tetraacetic acid; mixture of N-(2-aminoethyl)-3-aminopropylmethyldimethoxysilane and tetra(ethylene glycol)trimethoxysilane; mixture of 3-(trimethoxysilylpropyl)diethylenetriamine and tetra(ethylene glycol)trimethoxysilane; mixture of N-(trimethoxysilylpropyl)ethylenediamine, tridactic acid, sodium salt, and tetra(ethyleneglycol)trimethoxysilane; mixture of 2-(trimethoxysilylpropanol)-1,3-diamino-N,N,N′,N′-tetraacetic acid and tetra(ethylene glycol)trimethoxysilane; vinylmethoxysilane, vinyltrimethoxysilane, vinylethoxysilane, vinyltriethoxysilane, 3-aminopropyltriethoxysilane, 3-glycidoxypropyltrimethoxysilane, 3-methacryloxypropyltrimethoxysilane, 3-mercaptopropyltrimethoxysilane, N-(1,3-dimethylbutylidene)-3-(triethoxysilyl)-1-propanamine, N,N′-bis[3-(trimethoxysilyl)propyl]ethylenediamine, N-(beta-aminoethyl)-gamma-aminopropylmethyldimethoxysilane, N-(beta-aminoethyl)-gamma-aminopropyltrimethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-glycidoxypropylmethyldimethoxysilane, 2-(3,4-epoxycyclohexyl)ethyltrimethoxysilane, gamma-methacryloxypropyltrimethoxysilane, gamma-methacryloxypropyltriethoxysilane, gamma-mercaptopropyltrimethoxysilane, gamma-mercaptopropyltriethoxysilane, N-[2-(vinylbenzylamino)ethyl]-3-aminopropyltrimethoxysilane, and combinations thereof. Preferably, the oxidizable metallic surface is selected from the group consisting of steel, a steel alloy, a carbon steel, aluminum, copper, brass, and combinations thereof.

### BRIEF DESCRIPTION OF THE FIGURES

FIG. 1 shows a molecular structure of the disclosed monolayer on a silicon dioxide (glass) surface having free hydroxyl groups.

FIG. 2 shows an EPR oxidation profile of beer stored in a vial coated with the disclosed monolayer.

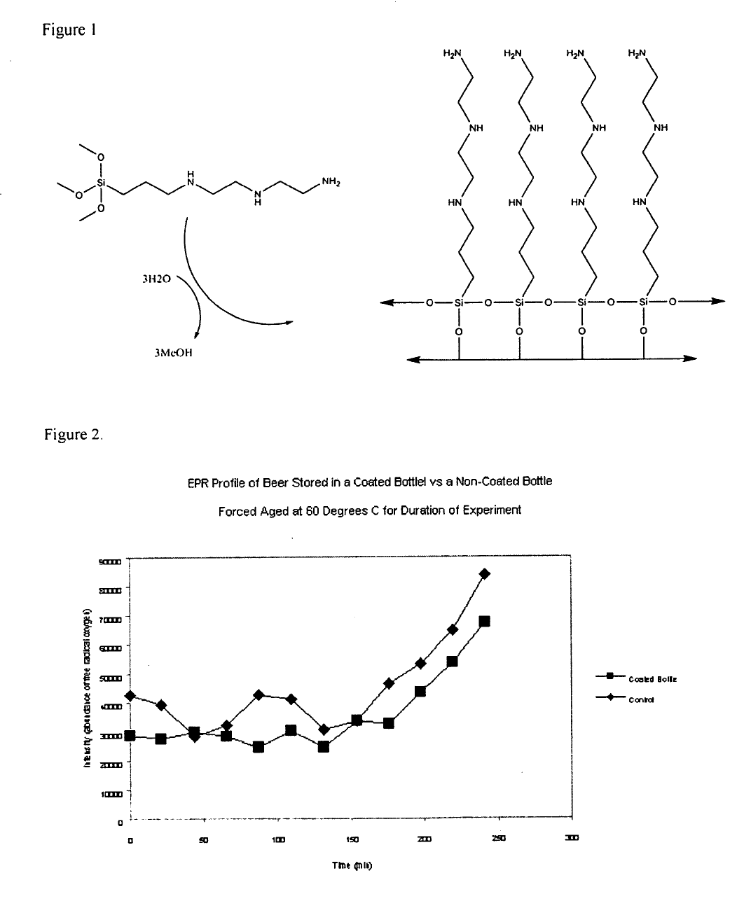

### DETAILED DESCRIPTION

The present disclosure provides a thin coating matrix on the surface of glass or an oxidizable metal that is polymerized in situ. The coating matrix comprise a single or multiple layer of a self-assembled surface comprising a monolayer or multiple layer of a compound selected from the group consisting of: N-(2-aminoethyl)-3-aminopropylmethyldimethoxysilane; (3-trimethoxysilylpropyl)diethylenetriamine; N-(trimethoxysilylpropyl)ethylenetriamine, triacetic acid, sodium salt; 2-(trimethoxysilylpropanol)-1,3-diamino-N,N,N′,N′-tetraacetic Acid; mixture of N-(2-aminoethyl)-3-aminopropylmethyldimethoxysilane and tetra(ethylene glycol)trimethoxysilane; mixture of 3-(trimethoxysilylpropyl)diethylenetriamine and tetra(ethylene glycol)trimethoxysilane; mixture of N-(trimethoxysilylpropyl)ethylenediamine, tridactic acid, sodium salt, and tetra(ethyleneglycol)trimethoxysilane; mixture of 2-(trimethoxysilylpropanol)-1,3-diamino-N,N,N′,N′-tetraacetic acid and tetra(ethylene glycol)trimethoxysilane; vinylmethoxysilane, vinyltrimethoxysilane, vinylethoxysilane, vinyltriethoxysilane, 3-aminopropyltriethoxysilane, 3-glycidoxypropyltrimethoxysilane, 3-methacryloxypropyltrimethoxysilane, 3-mercaptopropyltrimethoxysilane, N-(1,3-dimethylbutylidene)-3-(triethoxysilyl)-1-propanamine, N,N′-bis[3-(trimethoxysilyl)propyl]ethylenediamine, N-(beta-aminoethyl)-gamma-aminopropylmethyldimethoxysilane, N-(beta-aminoethyl)-gamma-aminopropyltrimethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-glycidoxypropylmethyldimethoxysilane, 2-(3,4-epoxycyclohexyl)ethyltrimethoxysilane, gamma-methacryloxypropyltrimethoxysilane, gamma-methacryloxypropyltriethoxysilane, gamma-mercaptopropyltrimethoxysilane, gamma-mercaptopropyltriethoxysilane, N-[2-(vinylbenzylamino)ethyl]-3-aminopropyltrimethoxysilane, and combinations thereof. Preferably, the beverage coatings are monolayers or up to 100 layers of polymerized monomers selected from the group consisting of N-(2-aminoethyl)-3-aminopropylmethyldimethoxysilane, (3-trimethoxysilylpropyl)diethylenetriamine, N-trimethoxysilylpropyl)ethylenediamine, triacetic acid, sodium salt, 2-(trimethoxysilylpropanol)-1,3-diamino-N,N,N′,N′-tetraacetic acid, mixture of N-(2-aminoethyl)-3-aminopropylmethyldimethoxysilane and tetra(ethylene glycol)trimethoxysilane, mixture of 3-trimethoxysilylpropyl)diethylenetriamine and tetra(ethylene glycol)trimethoxysilane, mixture of N-trimethoxysilylpropyl)ethylenediamine, triacetic acid, sodium salt and tetra(ethyleneglycol)trimethoxysilane, mixture of 2-(trimethoxysilylpropanol)-1,3-diamino-N,N,N′,N′-tetraacetic Acid and tetra(ethylene glycol)trimethoxysilane, and combinations thereof. Coatings containing tetra(ethylene glycol)trimethoxysilane or similar are designed to resist protein fouling if it is an issue for that particular application.

### Process for Applying Coatings

The coatings are applied to the containers of the composition of glass, oxidizable metal, or any other material with a hydroxylated surface or having free hydroxyl groups on the beverage container surface. The coatings are applied by either a spray or soak method.

Specifically, a solution of 0.1M of Silane (one of each of (1) N-(2-Aminoethyl)-3-aminopropylmethyldimethoxysilane, (2) (3-trimethoxysilylpropyl)diethylenetriamine, (3) N-trimethoxysilylpropyl)ethylenediamine, triacetic acid, sodium salt, (4) 2-(trimethoxysilylpropanol)-1,3-diamino-N,N,N′,N′-tetraacetic acid, (5) mixture of N-(2-aminoethyl)-3-aminopropylmethyldimethoxysilane and tetra(ethylene glycol)trimethoxysilane, (6) mixture of 3-trimethoxysilylpropyl)diethylenetriamine and tetra(ethylene glycol)trimethoxysilane, (7) mixture of N-(trimethoxysilylpropyl)ethylenediamine, triacetic acid, sodium salt and tetra(ethyleneglycol)trimethoxysilane, and (8) mixture of 2-(trimethoxysilylpropanol)-1,3-diamino-N,N,N′,N′-tetraacetic Acid and tetra(ethylene glycol)trimethoxysilane) in Toluene was prepared. A clean piece of glass was placed vertically upright in a test tube in the 0.1M solution for 90 min. Glass was removed and rinsed with toluene, hexanes, methanol, and ethanol. Glass slide was blown dry with nitrogen gas.

### Process for Functionalizing Surface

Glass was functionalized by using the silane derivative of diethylenetriamine (Triamine). The silane coating was stable to about pH 2.0 at about 250° C. and did not leach off the solid surface into a beverage. Thus, the selected chelating moiety and adsorbed metal ions (chelated) remain on the container wall.

Chemical characterization of the coatings is achieved via x-ray photoelectron spectroscopy (XPS) and contact angle. Table 1 below provides the XPS data for the Triamine coating on glass and stainless steel, as well as non-coated glass and stainless steel which represents a reference blank. Table 2 shows the contact angle data from triamine coated glass and a glass control samples from Table 1. The contact from the triamine sample is significantly different from the control further supporting the presence of the triamine coating.

TABLE 1
XPS Data for Coating 1 on Glass

| Sample | C (%) | O (%) | Si (%) | N (%) | Fe (%) | Cr (%) |
|---|---|---|---|---|---|---|
| Triamine | 36 | 38.07 | 19.2 | 6.1 | — | — |
| Glass | | | | | | |
| Blank Glass | 22.7 | 53.7 | 23.5 | 0.1 | — | — |
| Triamine | 57.7 | 28.6 | 3.9 | 6.2 | 1.4 | 2.3 |
| Stainless | | | | | | |
| Steel | | | | | | |
| Blank | 74 | 28.1 | 1.2 | — | 1.2 | 1.8 |
| Stainless | | | | | | |
| Steel | | | | | | |

The data set labeled “Triamine Glass” represents an average of 3 pieces of amber glass from 3 separate vials coated with (3-trimethoxysilylpropyl) diethylenetriamine.
The data set labeled “Control Glass” represents an average of 3 pieces of amber glass from 3 separate vials that were not coated with anything.
The data sets on stainless steel were analogous to the data set on glass accept for the substrate was 316 stainless steel.

TABLE 2
Contact angle data

| Sample | Contact Angle |
|---|---|
| Triamine (average) | 37.4 |
| Triamine (standard | 2.5 |
| deviation) | |
| Control (average) | 13.5 |
| Control (standard | 2.5 |
| deviation) | |

In beer, the anti-oxidation effects of the coatings were assessed using electron paramagnetic resonance (EPR) spectroscopy. As beer ages, EPR lag time for beer stored in a coated vessel increases when compared to a control (Uchida and Ono, J. Am. Brew. Chem. 57(4):145-150, 1999). The increase in lag time correlates to a lower concentration of free radical oxygen species, which when reduced correlates to a longer shelf life. Triaminecoated sample vials are prepared by filling them with an identical 0.1 M solution of the coating molecule in toluene for 90 min followed by the identical rinsing procedure as described above. EPR lag time for beer exposed to Triamine coated vials, increased when compared to a control. The increase in lag time correlated to a lower concentration of free radical oxygen species, which, when reduced, correlated to a longer shelf life. For beers that do not have an EPR lag time, exposure to Triamine coated vials slows the rate of free radical production during forced aging, indicating an increase in beer stability (FIG. 2).

FIG. 2 shows an EPR oxidation profile of Miller High Life beer that was force aged after 15 min storage in a vial coated with Triamine. The data set Triamine in FIG. 2 represents an average of 3 experiments. In each experiment, a 20 mL amber glass scintillation vial was coated with (3-trimethoxysilylpropyl)diethylenetriamine (ie Triamine) using the following procedure. The vials were rinsed with 0.1 M HCl, water, 0.1 M NaOH, followed by water and then dried in an oven for 1 hour at 110° C. The vials were then cooled to room temperature and filled with a 2% solution of (3-trimethoxysilylpropyl)diethylenetriamine in toluene for 5 min sealed at room temperature. The vials were emptied and rinsed with toluene, methanol, ethanol, and water (2×20 mL each). The coated vials were then filled with 20 mL of degassed (via sonication at room temperature) beer, and were sealed at room temperature for 15 min. The beer (10 mL) samples were transferred to a septumed 15 mL scintillation vial, and were analyzed by EPR spectroscopy using the American Society of Brewing chemists (ASBC) certified method described below. The data set labeled “Control” in FIG. 2 represents an average of 3 samples of beer that were stored in non-coated amber glass scintillation vials. All experimental procedures for the data set “Control” were identical to the data set “Triamine” except the vials used were non-coated.

The procedure for the ASBC EPR method is as follows. The samples were degassed and added to 15 mL septum capped vials. Next, the spin trap reagent N-t-butyl-phenylnitrone (PBN) was dispensed into the liquid, mixed thoroughly and the vial thus prepared was placed in a heating block at 60° C. The Bruker e-scan epr spectrometer was used to record EPR measurements every ˜20 minutes for approximately 3 hr, the samples remained in the heating block at 60° C. for the entire experiment. The reference reagent used in the experiment was 2,2,6,6-tetramethylpiperidine-N-oxyl (TEMPO) and was analyzed every ˜20 min during the experiment at 60° C. The error bars show the standard deviations for each measurement.

We claim:

1. A surface treatment monolayer or multiple layer for coating beverage container surfaces to prevent oxidation of the beverage, comprising a polymerized mixture of an aqueous formula (I) of a compound:
Silane Moiety-saturated alkane chain-chelating moiety (I)
wherein the chelating moiety is chosen to match the ions from the beverage.

2. The surface treatment monolayer or multilayer for coating beverage container surfaces to prevent oxidation of claim 1 wherein the composition is selected from the group consisting of: N-(2-aminoethyl)-3-aminopropylmethyldimethoxysilane; (3-trimethoxysilylpropyl)diethylenetriamine; N-(trimethoxysilylpropyl)ethylenetriamine, triacetic acid, sodium salt; 2-(trimethoxysilylpropanol)-1,3-diamino-N,N,N′,N′-tetraacetic acid; mixture of N-(2-aminoethyl)-3-aminopropylmethyldimethoxysilane and tetra(ethylene glycol)trimethoxysilane; mixture of 3-(trimethoxysilylpropyl)diethylenetriamine and tetra(ethylene glycol)trimethoxysilane; mixture of N-(trimethoxysilylpropyl)ethylenediamine, tridactic acid, sodium salt, and tetra(ethyleneglycol)trimethoxysilane; mixture of 2-(trimethoxysilylpropanol)-1,3-diamino-N,N,N′,N′-tetraacetic acid and tetra(ethylene glycol)trimethoxysilane; vinylmethoxysilane, vinyltrimethoxysilane, vinylethoxysilane, vinyltriethoxysilane, 3-aminopropyltriethoxysilane, 3-glycidoxypropyltrimethoxysilane, 3-methacryloxypropyltrimethoxysilane, 3-mercaptopropyltrimethoxysilane, N-(1,3-dimethylbutylidene)-3-(triethoxysilyl)-1-propanamine, N,N′-bis[3-(trimethoxysilyl)propyl]ethylenediamine, N-(beta-aminoethyl)-gamma-aminopropylmethyldimethoxysilane, N-(beta-aminoethyl)-gamma-aminopropyltrimethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-glycidoxypropylmethyldimethoxysilane, 2-(3,4-epoxycyclohexyl)ethyltrimethoxysilane, gamma-methacryloxypropyltrimethoxysilane, gamma-methacryloxypropyltriethoxysilane, gamma-mercaptopropyltrimethoxysilane, gamma-mercaptopropyltriethoxysilane, N-[2-(vinylbenzylamino)ethyl]-3-aminopropyltrimethoxysilane, and combinations thereof.

3. The surface treatment monolayer or multilayer for coating beverage container surfaces to prevent oxidation of claim 1 wherein the beverage container surface is selected from the group consisting of glass, steel, a steel alloy, a carbon steel, aluminum, copper, brass, and combinations thereof.

4. A process for treating a surface of a beverage container having a surface, comprising:
(a) providing an aqueous solution of formula (I) of a compound:
Silane Moiety-saturated alkane chain-chelating moiety (I);
wherein the chelating moiety is chosen to match the ions from the beverage;
(b) applying the aqueous solution of formula (I) to the surface of the beverage container.

5. The process for treating a surface of a beverage container having a surface of claim 4, wherein the composition is selected from the group consisting of: N-(2-aminoethyl)-3-aminopropylmethyldimethoxysilane; (3-trimethoxysilylpropyl)diethylenetriamine; N-(trimethoxysilylpropyl)ethylenetriamine, triacetic acid, sodium salt; 2-(trimethoxysilylpropanol)-1,3-diamino-N,N,N′,N′-tetraacetic acid; mixture of N-(2-aminoethyl)-3-aminopropylmethyldimethoxysilane and tetra(ethylene glycol)trimethoxysilane; mixture of 3-(trimethoxysilylpropyl)diethylenetriamine and tetra(ethylene glycol)trimethoxysilane; mixture of N-(trimethoxysilylpropyl)ethylenediamine, tridactic acid, sodium salt, and tetra(ethyleneglycol)trimethoxysilane; mixture of 2-(trimethoxysilylpropanol)-1,3-diamino-N,N,N′,N′-tetraacetic acid and tetra(ethylene glycol)trimethoxysilane; vinylmethoxysilane, vinyltrimethoxysilane, vinylethoxysilane, vinyltriethoxysilane, 3-aminopropyltriethoxysilane, 3-glycidoxypropyltrimethoxysilane, 3-methacryloxypropyltrimethoxysilane, 3-mercaptopropyltrimethoxysilane, N-(1,3-dimethylbutylidene)-3-(triethoxysilyl)-1-propanamine, N,N′-bis[3-(trimethoxysilyl)propyl]ethylenediamine, N-(beta-aminoethyl)-gamma-aminopropylmethyldimethoxysilane, N-(beta-aminoethyl)-gamma-aminopropyltrimethoxysilane, gamma-aminopropyltrimethoxysilane, gamma-aminopropyltriethoxysilane, gamma-glycidoxypropyltrimethoxysilane, gamma-glycidoxypropyltriethoxysilane, gamma-glycidoxypropylmethyldimethoxysilane, 2-(3,4-epoxycyclohexyl)ethyltrimethoxysilane, gamma-methacryloxypropyltrimethoxysilane, gamma-methacryloxypropyltriethoxysilane, gamma-mercaptopropyltrimethoxysilane, gamma-mercaptopropyltriethoxysilane, N-[2-(vinylbenzylamino)ethyl]-3-aminopropyltrimethoxysilane, and combinations thereof.

6. The process for treating a surface of a beverage container having a surface of claim 4, wherein the beverage container surface is selected from the group consisting of glass, steel, a steel alloy, a carbon steel, aluminum, copper, brass, and combinations thereof.
